(19) United States
(12) Patent Application Publication
(10) Pub. No.: US 2002/0156611 A1
(43) Pub. Date: Oct. 24, 2002

(54) Performance simulation process, and multiprocessor application production process, and devices for implementing said processes

(75) Inventor: Eric Lenormand, Boulogne (FR)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: THALES, PARIS (FR)

(21) Appl. No.: 10/066,444

(22) Filed: Feb. 5, 2002

(30) Foreign Application Priority Data
Feb. 5, 2001 (FR) 01 01807

(51) Int. Cl. G06F 9/45

(52) U.S. Cl. 703/22

(57) ABSTRACT

The disclosure relates to a process for simulating a multiprocessor application placed on a target architecture, charactenzed in that it includes at least the following steps:

(a) a step (E2) to prepare the simulation to produce a services graph (D3), using firstly a tasks graph (D2) and secondly a list of mechanisms and their definition (A2);

(b) a stop (E3) to execute the simulation to determine the performance of the placed application, using a behavioral model (A3) of the target architecture and the services graph (D3). The disclosure also relates to a process for producing a multiprocessor application, characterized in that It includes at least the following steps:

(a) a step (E1) to place the application on the target architecture using firstly a funcUoral desription (D1) of said application, and secondly the list of resources (A1) of the target architecture in order to produce a tasks graph (D2);

(b) a step (E2) to prepare a simulation to produce a services graph (D3) starting firstly from a tasks graph (D2), and secondly from a list of mechanisms and their definitons (A2);

(c) a step (E3) to execute the simulation to determine the performance of the placed application, using a behavioral model (A3) of the target architecture and the services graph (D3). The invention is particularly applicable to multiprocessor applications requiring high computing power, such as systematic signal processing (SSP) for radar, Image processing, and real-time data compression.

### BACKGROUND OF THE INVENTION

This invention relates to a performance simulation process and a process for creating multiprocessor applications, and devices for implementing said processes. It is particularly applicable to multiprocessor applications requiring high computing power such as systematic signa procssing (SSP) for radar, image processing, and real-time data compression.

### DESCRIPTION OF THE PRIOR ART

A multiprocessor application is an application that will be executed on a multiprocessor architecture. An architecture comprises hardware elements and software elernents. Hardware elements include, for example, processors, memories, special purpose circuits and data buses. Software elements include, fbr example,.basic instruction sets made available to the programmer called APIs (Application Programming lnterface), low level communication programs, and a scheduler. Hardware elements of an architecture are also called resources. Softwre elements of an architecture are also called services.

Placement is a step that takes place during the production of multiprocessor applications. It consists of transforming an application described functionally into a set of sub-applications each of which will be run on one processor in a target architecture. During the placement step, an attempt is made to have calculations executed in parallel by several processors in the target architecture. A first way of executing the calculations in parallel, called task parallelism, consists of distributing different tasks on several processors or groups of processors. The various tasks are then executed at the same time on different processors or groups of processors, A second manner of executing calculations in parallel, called data parallelism, consists of distributing a single task on several processors. In this second operating mode called SIMAD (Single Instruction Multiple Data) or SPMD (Single Program Multiple Data), several processors execute calculations for the same task but on different data at the same time and in a synchronized manner,

Placement usually includes a step called partitioning, a step called mapping and a stp called scheduling. Partiftoning consists of starting from a functionally described application, and firstly breaking the application down into separate subsets of elementary calculation steps (task parallelism) called tasks and Y or secondly sharing uniform data blocks in elementary data blocks (data parallelism). Assignment, known as “mapping”, consists of allocating elementary tasks and elementary data blocks to elements of the architecture such as processors for tasks, and memories for data blocks. Scheduling consists of determining the tasks execution chronology. The multiprocessor architecture chosen is frequently called the target architecture. The application may be functionally described by a high level software or by a graphic representation or DFG (Data Flow Graph). The tasks can then be described in a forrn that can be handled by code generation tools (for example compilers) or in the form of codes that can be used by elementary processors.

Good placement gives an efficient architecture, in other words it uses the capabilities (calculation power, corrmunication speeds) of its resources to their best advantage. Consequently, this type of placement can save hardware components in the architecture. For example, a target architecture may change from 20 electronic boards to 10 electronic boards, due to better placement of the same application.

The placement work for applications on target architectures is complex and is consequently long and expensive - particularly if high execution efficiencies are required. Moreover. efficient placement does not usually allow any flexibility. If it is required to add functions to a given application or to change the target architecture (retrofit), all the placement work has to be repeated.

Other steps may be necessary during the implementation of multiprocessor applications. These include performance simulation necessary to evaluate the real-time behavior of the placed application before executing it on the real target architecture. This performance simulation depends firsty on the target architecture and secondly on the placement These other steps need to be restarted every time that the architecture is changed, and this can be long and expensive.

Architectures with high level services are sometimnes used to facilitate the creation of multiprocessor applications. These services perform some of the details particularly related to cohesion between processors, and the programmer does not need to concern himnself with these details. The disadvantage is that this type of architecture is complex and it uses more resources than conventional architectures. Furthermore, the real-time behavior of this type of architecture is less predictable. The placement efficiency can be measured by the number of calculation operations carried out by a target architecture resource compared with its theoretical capacity, and it is more difficult to control and is frequently lower for this type of target architectures.

This type of solution is not suitable for applications requiring high computing power such as systematic signal processing (SSP) for radars image processing, and real-time data compression. These systematic signal processing (SSP) type applications require increasingly voluminous architectures to be executable in real time; these also require some optimization.

### SUMMARY OF THE INVENTION

One purpose of the present invention is to overcome the disadvantages mentioned above and particularly to reduce the time necessary to create multiprocessor applications while optimizing placement of said applications, and also making it easier to change the target architecture.

Consequently, the invention is a process for simulating a multiprocessor application placed on a target architecture, characterized in that it includes at least the following steps:

(a) a step (E2) to prepare the simulation to produce a services graph (D3), using firstly a tasks graph (D2) and secondly a list of mechanisms and their definition (A2);

(b) a step (E3) to execute the simulation to determine the performance of the placed application, using a behavioral model (A3) of the target architecture and the services graph (D3).

The invention is also a process for producing a multipmcessor application, characterized in that it includes at least the following steps:

(a) a step (E1) to place the application on the target architecture using firstly a functional description (D1) of said application, and secondly the list of resources (A1) of the target architecture in order to produce a tasks graph (D2);

(b) a step (E2) to prepare a simulation to produce a services graph (D3) starting firstly from a tasks graph (D2), and secondly from a list of mechanisms and their definitions (A2);

(c) a step (E3) to execute the simulation to determine the performance of the placed application, using . a behavioral model (A3) of the target architecture and the services graph (D3).

The invention also relates to devices to implement said processes.

The main advantages of the invention are that it enables a behavioral simulation in which the simulated time is incremented to coincide exactly with the end of execution of a services and the precirion of which can easily be adapted at minimum cost, simply by modifying behavioral models.

### BRIEF DRESCRIPTION OF THE DRAWINGS

Other characteristics and advantages of the invention will become clear on reading the following description of preferred embodiments, taken only as non-limitative examples, with reference to the attached drawings of which:

FIG. 1 shows an embodiment of a multiprocessor application implementation according to the invention in the form of a block diagram;

FIG. 2 shows an example of placement in the form of a block diagram;

FIG. 3 shows an example of a placement workshop for embodiment of the application production process illustrated in FIG. 1;

FIG. 4 shows an example of a behavioral model used in the placement workshop illustrated in FIG. 3, in the form of an objects diagram;

FIG. 5 shows an example of objects used during a simulation in the placement workshop illustrated in FIG. 3, in the form of an objects diagram,

FIG. 6 shows an example of a class diagram corresponding to the resources of the target architecture;

FIG. 7 shows an example of a class diagram corresponding to mechanisms;

FIG. 8 shoWs an example of objects used during a simulation preparation step, in the form of an objects diagram;

FIGS. 9, 10, and 11 shows examples of classes corresponding to tasks, mechanisms and services;

FIG. 12 shows a simulation example.

### DESCRIPTION OF PREFERRED MEMBOIMENTS

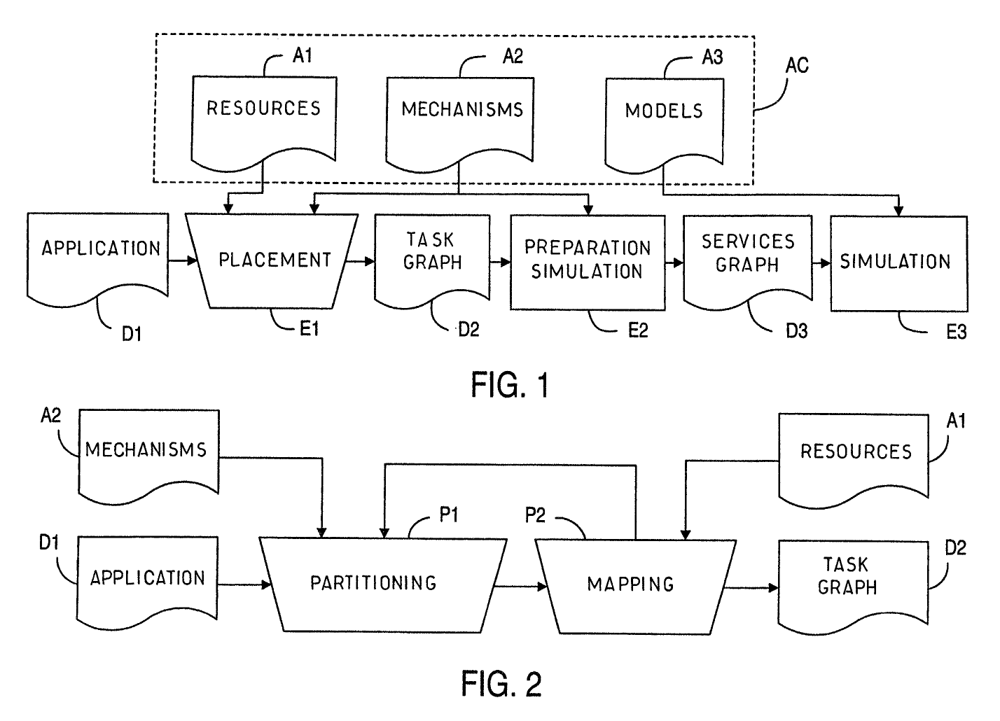

We shall now refer to FIG. 1, which shows an embodiment of multiprocessor applications according to the invention in the form of a block diagram. We usually use a software workshop to make multiprocessor applications. This type of workshop may comprise one or several programs cooperating together and exchanging data in a given format. A user of this type of workshop is called a mapper. This workshop depends on the target architecture on which the application will be executed.

The unplaced application D1 is described functionally, in other words independently of the architecture. This description Dl of the application may include calculation tasks independent of any architecture. For example, the application may be a SSP application. It comprises sequences of tasks called loop nests that are well structured and parallel. Each loop nest contains a calt to a procedure or macrn-instruction usually corresponding to a table transformation, In other words a function of a signal processing library such as an FFT. Processing is regular and is done on multidimensional signals, and data are organized in tables in which the dimensions (for example source frequency, recurrence time, pointing time) are referred to by vectors on which individual processing will be done. The application is globally represented by a non-cyclic data flow graph in which the application places each element of the table only once. Finally, execution of the application does not depend on external events or results of calculations made during execution, so that execution is predictable. In other words, the execution of the application is deterministic.

Obviously, the invention is applicable to any type of SSP application and particularly to applications that are deterministic by parts. These applications that are deterministic by parts comprise sequences of deterministic processing with a limited duration that succeed each other in time in an order than cannot generally be predicted in advance. For example, this is the case for rnulti-mode radar processing.

In a placement step E1, the calculation tasks are distributed on several groups of calculation units of a particular target architecture. FIG. 2 which shows a placement example in the fobm of a block diagram. This placement may include a partitioning step P1 and a mapping step P2.

Partitioning P1 may be done by task or by data. For example, with partitioning by tasks (parallelism of tasks), a calculation can be divided into several separate elementary calculation steps represented by tasks or sets of tasks. These separate elementary steps will be executed by separate sub- sets of the target architecture called segments. For example, with partitioning by data (data parallelism), data used by separate elementary steps can be divided into several data groups represented by parts of tables. These data groups will be processed by separate subsets of the target architecture.

In mapping step P2, the separate elementary calculation steps may, for example, be allocated to architecture segments. In particular, calculation tasks may be allocated to groups of calculation units. Furthermore, data groups used by these separate elementary steps can be allocated to pats of architecture segments. In particular, the different parts of a data table may be allocated to different calculation units of a segment. The mapping P2 is used to determine the resources Al of the target architecture that will be involved when a task is executed.

The calculation tasks are used to carry out operations on data such as digital filtering. The application will be executed on a particular architecture. This architecture includes services that will carry out these calculations. The architecture also includes services for making data movements. A data movement is broken down into several services. For example, a first service programs a DMA (Direct Memory Access) controller, a second service performs the sequence of data movement. These services are obviously different in different architectures. Thus, the same application performing the same function will be written differently depending on the architecture on which it will be executed,

According to the invention, a programming interface will be created at a higher level than the services, in order to reduce the time necessary to create multiprocessor applications. Consequently, servies are grouped in Mechanisms A2. Mechanisms A2 depend on the target architecture. They correspond to the functions used by tasks. A mechanism is an operation that a task repeats several times. There are calculation mechanisms and data movement mechanisms. Calculation nechanisms represent functions that may occur in the functional description D1 of the application. These mechanisms may correspond to basic functions of a library such as the ifscalar product or the discrete Fourier Transform. These mechanisms may also correspond to specific functions of a particular application, such as a compression function or an encryption function. For example, data movement mechanisms can be used to move data in a table, distribute in a first set of memories in the target architecture, to a second set of memories in the target architecture.

The partition step P1 and mapping step P2 may be done manually by the mapper using a placement tool. During partiuoning P1, the placement tool may use a list of mechanisms A2 of the architecture. During mapping P2, the placement tool can use a list of resources A1 of the architecture. At the end of placement E1, there is a tasks graph D2, said tasks being assigned to the resources of the target architecture.

The remainder of the description of the example multiprocessor application production will be described with reference to FIG. 1 again. In a second step E2, the tasks graph is converted into a services graph D3. This step E2 prepares a sinmulation of the execution of the application on the target architecture.

Advantageously, the workshop does this step D2 to prepare the simulation automatically. The mechanism associated with each task in the tasks graph is converted into a set of services, The workshop uses the definition of each mechanism, in other words the list of services corresponding to each

The service graph D3 can then be used in a simulation step E3. This simulation is used to determine the performance of the placed application. If this performance is not satisfactory, the mapper can modify this placement using the placement tool and restart a simulation.

During the simulation, the workshop uses a behavioral model A3 of the target architecture. This model A3 describes the behavior of the architecture faced with service requests, in other words when the application is being executed. In particular, this model A3 can determine use of resources of the target architecture while services are running. For example, a movement service that uses a data bus can be slowed down if this bus is already in use by another service. Model A3 can also be used to determine the order of execution of services in the list of services that can be executed at a given moment.

Information AC about a particular target architecture used by the workshop includes:

the list of resources A1

the list of mechanisms and their definitions A2 and a behavioral model A3.

All this Infrmation AC is memorized in a form that makes it easy to adapt the workshop to new taret architectures.

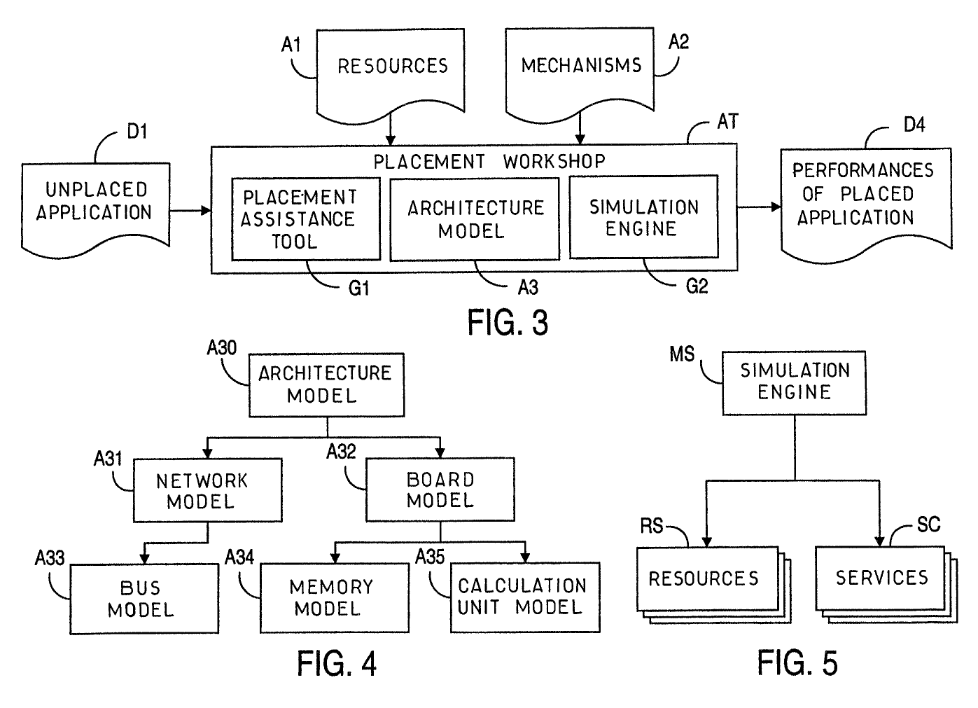

We shall now refer to FIG. 3 which shows an example of a placement workshop AT in which the application creation process according to the invention illustrated in FIG. 1 can be used. This workshop comprises a placement aid G1, an architecture model A3, and a simulation engine G2. The placement aid G1 is used to place the application as illustrated in FIG. 2. The architecture model A3 is used during the simulation by the simulation engine G2 to determine the performance D4 of the placed application. The list of resources Al and the list of mechanisms and their definitions A2 may be stored in one or severl text files that are interpreted by the placement workshop. Consequently, the workshop AT may incorporate methods of reading firstly the list of resources A1 of the target architecture, and secondly the list of mechanisms and their definitions A2.

A target architecture may include resources such as calculation units, mernories and data buses. The list of resources A1 comprises a description of the organization of these resources. These resources are usually organized regularly so that calculations carried out by the application can be put in parallel. The list of resources A1 is used firstly during the placement step E1 and secondly during the simulation step E3. The list of calculation units and memories is used during the placement step E1. A complete list of resources is used during the simulation stop E3. Each of the subsets of the target architecture on which calculations involving data parallelism are carried out is referred to as segment architecture. A segment architecture in which the resources are arranged regularly so that they can be grouped in tables of identical elements is referred to as a repetitive segment architecture. When these tables have several dimensions, these dimensions can be represented by levels. A level often corresponds to an architecture resource, such as an electronic board, on which other resourb,s for example such as memories, are placed Each level comprises elements such as firstly homogeneous sets, and secondly speciftc resources, Homogeneous sots on one level may include lower level elements.

The list af resources A1 of a repetitive segment architecture may be described in a file formatted like the rows and columns of a table, as follows:

| | | | | | |
|---|---|---|---|---|---|
| BLOC | Tiger | | | | |
| CPU | UcTiger | 1 | | 150 | MHz |
| MEM | RamInt | 4000 | Kbyte | 400 | Kbyte/s |
| MEM | RamProg | 2000 | Kbyte | 600 | Mbyte/s |
| BUS | PortLink | 150 | Mbyte/s | | |
| BUS | PortBus | 1200 | Mbyte/s | | |
| OTHER | Dma | 8 | | | |
| END | | | | | |
| BLOC | Board | | | | |
| INC | Tiger | 6 | | | |
| MEM | RamExt | 1024 | Kbyte | 600 | Mbyte/s |
| MEM | DPRam | 500 | Kbyte | 1000 | Mbyte/s |
| BUS | BusExt | 600 | Mbyte/s | | |
| BUS | LinksIn | 300 | Mbyte/s | | |
| BUS | LinksInter | 150 | Mbyte/s | | |
| END | | | | | |
| SEGMENT | SegA | | | | |
| INC | Board | 8 | | | |
| BUS | Network | 133 | Mbyte/s | | |
| END | | | | | |
| SEGMENT | SegB | | | | |
| INC | Board | 4 | | | |
| BUS | Network | 133 | Mbyte/s | | |
| END | | | | | |

The first column in this table contains keywords. These keywords are “BLOC”,“CPU”, “MEM”, “BUS”, “OTHER”, “END”, “INC”, and “SEGMENT”,

The “CPU”, “MFMll”, “BUS”, and “OTHER” keywords represent calculation unit, memory, bus or other types of resources. They are followed by the name of the resource and the characteristic parameters of this resource;, Thus, on the fifth line of this table, it can be ween that the target architecture comprises buses called “PortLink” characrized by a transfer speed of 150 Mbytes/s.

The “BLOC” and “SEGMENT” keywords represent groups of resources, the name of which follows thie keyword. Each group ends in the “END” keyword. All resources of a resource group are at the same level in the architecture.

A group of resources may be considered as a resource of another higher level group. When a group of resources is included in a higher level resource group, the “INC” keyword is used followed by the group name and the number of occurrences of this group. Thus, on the tenth line of this table, it can be seen that the “Board” group includes six occurrences of the “Tigee” group.

Obviously, the list of resources Al could be described differently, ,fc. exams: using a binary file.

The list of mechanisms and their definitions A2 may be described in a file formatted in rows and columns of table such as;

| | | | |
|---|---|---|---|
| CALC | Tiger | Mulac | |
| IN | RamInt | Complex32 | 8 |
| IN | RamInt | Complex32 | 8 |
| OUT | RamInt | Complex32 | 1 |
| CYCLES | 5 | 1 | 3 |
| END | | | |
| CALC | Tiger | FFT512 | |
| IN | RamInt | Complex32 | 512 |
| IN | RamInt | Complex32 | 512 |
| OUT | RamInt | Complex32 | 512 |
| CYCLES | 10 | 4608 | 12 |
| END | | | |
| MOVE | Board | DPtol | |
| SOURCE | DPRam | | |
| DEST | RamInt | | |
| EQUATION | XA -> XY | | |
| SERVICE | CoreService | S_DPtol | |
| END | | | |
| MOVE | Board | Itol | |
| SOURCE | RamInt | | |
| DEST | RamInt | | |
| EQUATION | XYA -> XAY | | |
| SERVICE | CoreService | S_Itol | |
| END | | | |
| MOVE | Board | ItoE | |
| SOURCE | RamInt | | |
| DEST | RamExt | | |
| EQUATION | XY -> XA | | |
| SERVICE | CoreService | S_ItoE | |
| END | | | |
| MOVE | Board | Etol | |
| SOURCE | RamExt | | |
| DEST | Ramint | | |
| EQUATION | XA -> XY | | |
| SERVICE | CoreService | S_Etol | |
| END | | | |
| MOVE | Board | EtoE | |
| DEST | RamExt | | |
| EQUATION | XA -> AX | | |
| SERVICE | CoreService | S_EtoE | |
| END | | | |
| MOVE | SegA | AtoB | |
| SOURCE | RamExt | | |
| DEST | RamExt -> SegB | | |
| EQUATION | XA -> AX | | |
| SERVICE | CoreService | ProgDMAext | |
| SERVICE | NetworkService | S_AtoB | |
| END | | | |

The first column in this table includes keywords. These keywords are “CALC”, “MOVE”, “END”, “IN”, “OUT”, “CYCLES”, “SOURCE”, “DEST”, “EQUATIONS”, “SERVICE”.

The “CALC” and “MOVE” keywords represent calculation and data movement mechanisms, respectivey. They are followed by the name of the resource group that will use the mechanism, and by the name of the mechanism. Thus, on the first line in the table, it can be seen that the “Mulac” calculation mechanism will be used by the “Tiger ” resource group, The “END” keyword wilt be used to stop the definition of a calculation mechanism or a movement.

The “IN”, “OUT”keywords represent the inputs and outputs of the calculation mechanisms, respectively. They are followed by the name of the memory in which the data are memorized, the nature of the data used (integer, real, complex) and the number of data. Thus, the “Mulac” calculation mechanism uses two tables containing 8 “Complexa32” type numbers memorized in a “Ramint” memory as input, and produces a “Complex32” type number memorized in a “Ramint ” memory as output.

The “CYCLES” keyword represents the number of cycles used by a calculation mechanism. It is followed by the number of start body and end cycles. In other words, the “CYCLES” keyword is followed by three integer numbers representing the number of cycles necessary to initialize the calculation, to complete an iteration, and to end the calculation

The “SOURCE” and “DEST” keywords represent the sour and destination memories of the movement mechanism, respectively. They are followed by 25 the name of the source and destination memories. Thus, the “Etol” movement mechanism moves data from a “RamExt” memory to a “Ramint” memory. The “EOUATION” keyword shows the manner in which the distribution of data changes from one memory to another. It is followed by a name corresponding to this distribution change,

The “SERVICE” keyword represents one of the services that implement a movement mechanism. This keyword is followed by the service type and the service name. Thus, the “AtBf” data movement is broken down into two services, firsty “ProgDMAext” of the “ICoreService” type and secondly “S_AtoB” of the “NetworkEervice” type.

Obviously, the list of mechanisms and their definitions A2 could be described differently, for example using a binary flie.

The placement workshop AT may be produced using an object programming language such as C++. In other words, all modules in the Workshop AT can be produced using the C++ object language. The behavioral model A3 then forms an integral part of the workshop. It can be compiled with the workshop or it may be compiled separately, for example in a dynamic library, Obviously, the various modules in the workshop can be made using different programrning languages, for example using encapsulation techniques.

We shall now refer to FIG. 4 which illustrates an example of a behavioral model A3 in the form of an objects diagram. This behavioral model A3 is used during the simulation. In particular, it is used to determine if a service can be executed at a particular instant of the simulation, and if so, the speed as a function of use of the resources of the target architecture at this given moment of the simulation. The behavioral model A3 illustrated in FIG. 4 is a composite object illustrating several objects A30, A31, A32, A33, A34, A35. The objects A30, A31, A32, A33, A34, A35 include behavioral models. These objects are class instances inheriting the properties of a common class. This common class is used to define generic methods of behavioral models. The simulation engine uses these generic methods. When the target architecture is modified, the behavioral models must be adapted to the new target architectures Due to this model structure using generic methods, there is no need to modify the other parts of the Workshop AT, particularly the simulation engine G2.

Advantageously, the objects A30, A31, A32, A33, A34, A35 are organized into levels in the same way as the resources of the target architecture. Thus, objects corresponding to a level comprise references to objects corresponding to lower levels. For example, the object including the behavioral architecture model A30 comprises a reference to an object including firstly a board behavioral model A32 and secondly a reference to an object including a network behavioral model A31. Similarly, the object including a network behavioral model A31 includes a reference to the object including a bus behavioral model A33. The object including a board behavioral model A32 includes a reference to the object including firstly a memory behavioral model A34, and serc,idly a reference to the object including a calculation unit behavioral model A35.

We shall now refer to FIG. 5 which illustrates an example of objects used in the placement workshop AT during a simulation, in the form of an objects diagram.

Most data necessary for the simulation engine G2 can be memorized in an object MS. This object related to the Simulation engine MS can in particular memorize the simulated time, the occupancy state of resources (mnemnories and calculation units) and the list of tasks being executed. Consequently, this Simulation engine object MS can include references to other objects RS, SC representing firstly resources of the target architecture, and secondly its services, respectively

Objects RS representing resources of the target architecture include attributes in which characteristic parameters of resources are memorized. These parameters, such as the transfer rate of a bus, can be read by the placement workshop AT in a file including the list of resources A1. This file containing the list of resources Al may be the same as that mentioned before; When this file is read, resource objects RS can be created for each resource in the target architecture. According to a first advantageous embodiment, a resource object RS can correspond to a group of identical resources in the target architecture. A single resource object RS can be created to represent a resources table. This Object RS comprises an azMribule to memorize the number of resources present in the target architecture. For example, for a repetitive segment architecture, this attribute may be a table of integers, The product of the integers in this table corresponds to the number of these resources present in the target architecture. The dimensions of this table correspond to the levels of the target architecture.

According to one advantageous variant, a resource object RS may correspond to a group of resources. It then includes a reference to other resource objects RS representing resource groups or resources in turn, These groups of resources are represented by the “BLOC” and “SEGMENT” keywords, in the example of the file mentioned above.

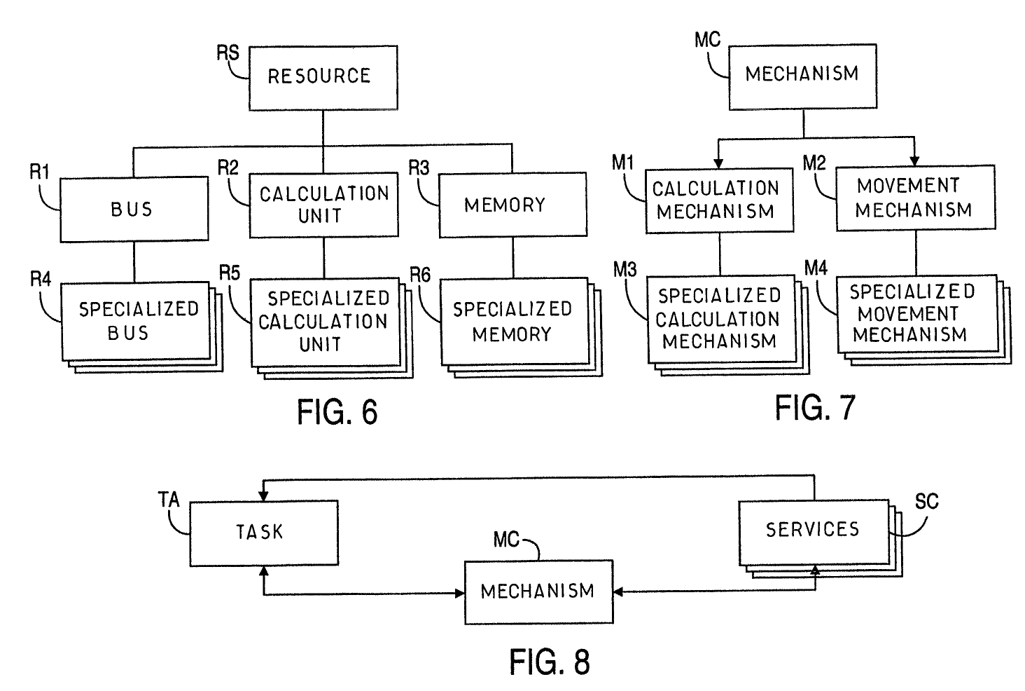

We shall now refer to FIG. 6 which illustrates an example of a class diagram corresponding to resources in the target architecture. A resource object RS is an instance of a resource object class. The same reference RS is used to denote the object and the class. According to one advantageous embodiment, specialized object dasses R1 , R2, R3 may correspond to buses, calculation units and memories, respectively. These object classes R1, R2, R3 inherit properties of the resource object class RS. If the “OBUSY keyword appears in a file containing the list of resources Al, the placement tool AT can create an object by instantiating class RI. Similarly for the “CPU”(CPU) keyword, the placement tool AT can create an object by instantiating class R2. For the “BUS” keyword, the placement tool AT can create an object by instantiating class R3. For the “OTHER” keyword, the placement tool AT can create an object by instantiating the RS class.

Advantageously, other more specialized resource object classes R4, R5, R6 can be defined, for example corresponding to particular buses, particular calculation units and particular memories. These classes R4, R5, R6 then inherit the properties of classes R1, R2, R3 respectively. Other keywords can then be used in the architecture description file A1 to denote these particular resources. In this way, the target architecture can easily be changed, even when specialized resources have to be defined. All that are modified are the essential parts of the placement workshop AT. New behavioral models can be added or modified, and new resource classes R4, R5, R6 can be added or modified without modifying the rest of the Workshop AT.

The objects MC representing mechanisms of the target architecture include attributes in which characteristic pararneters of mechanisms are memorized. Some parameters such as the number and type of elements used as input by a calculation mechanism, can be read by the placement workshop AT in a file containing the list of mechanisms and their defnitions A2. This file containing the list of mechanisrns and their definitions A2 may be the same file as was mentioned above. The mechanism objects MC may be created after the parameters in this file have been read.

We shall now refer to FIG. 7 which illustrates an example of a class diagram corresponding to mechanisms. A mechanism object MC is an Instance of a mechanism object class. The same reference MC is used to denote the object and the class. According to one advantageous embodiment, specialized object classes M1, M2 can correspond to calculation mechanisms and movement mechanisms respectively. These object classes M1, M2 inherit the properties of the mechanism object class MC. If the “CALCUL ” keyword appears in the file containing the list of mechanisms and their definitions A, the placement tooi AT can create an object by instantiating class MI. Similarly for the “MOVEMENT” keyword, the placement tool AT can create an object by instantiating class M2.

Advantageously, other more specialized mechanism object classes M3, M4 can be defined corresponding to particular calculations and for example particular movements. These classes M3, M4 then inherit the properties of classes M1, M2 respectively. Other keywords can then be used in the architecture description file A2 to denote these particular mechanisms. in this way, the target arhitecture can be changed easily even when it is necessary to define specialized services. All that are modified are the essential parts of the placement workshop AT. New mechanism classes M3, M4 can be added or modified without modifying the rest of the Workshop AT. during step E2 in preparation of the simulation, in the form of an objects diagram.

Starting from the description of the unplaced application D1, the placement workshop AT can generate an unplaced tasks graph. These tasks can be represented by Objects TA containing attributes related to these tasks. One of the attributes of Objects TA may be a reference to a mechanism object MC corresponding to the mechanism used by the task. Simnilarly, one of the attributes of the mechanism object MC may be a reference to the Task object TA. During the simulation preparation step, the rmechanism object MC may generate service objects SC. The attributes of the mechanism object MC may include references to the created service objects SC. Similarly, the attributes of service objects SC can include a reference to the mechanism object MC that created them. Furthermore, the attributes of service objects SC can include a reference to the Task object TA. Similarly, a services graph D3 represented by service objects D3 can be obtained from the task graph D2 represented by Task objects TA.

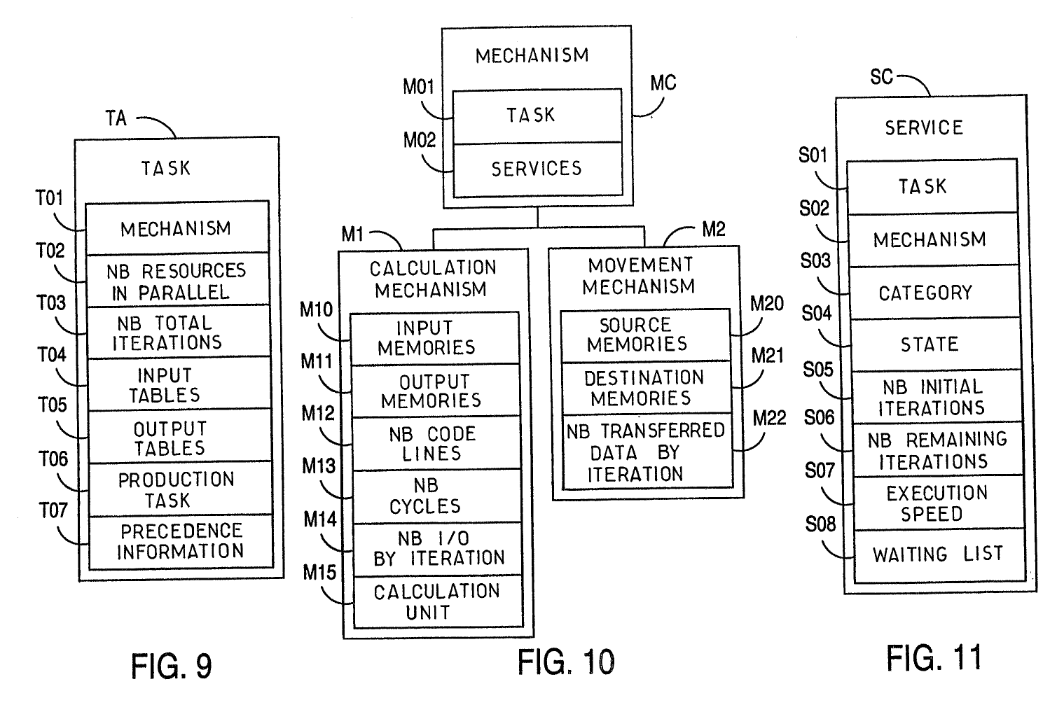

We shall now refer to FIGS. 9, 10, and 11 illustrating examples of classes TA, MC, SC, corresponding to tasks, mechanisms and services.

The Task object class TA illustrated in FIG. 9 includes attributes T01, T02, T03, T04, T05, T06, T07. Attribute T01 is a reference to a mechanism object. Attribute T02 is an integer or a table of integers used in the placement step E1 These integers correspond to a number of resources of the target architecture used in parallel. For example, if a calculation task is carried out in parallel on 10 boards each comprising 5 calculaltion units, these numbers will be 10 and 5, The attribute T03 corresponds to a number of iterations carried out by the task sequentially (not in parallel). A task may include several nested loops, for example a first loop with 8 iterations, inside which another loop of 32 iterations is nested. In this case, the attribute T03 will contain the numbers 8 and 32. The total number of iterations carried out by the task is the product of these numbers, in other words 8 times 32. The total number of elementary calculations carried out sequentially or in parallel is the product of the first numbers memorized in attribute T02 and the second numbers riernorize in attrbute T03.

Attributes T04 and T05 are references to objects representing tables used by the input task and the output task respectively. For example, a calculation task uses two input tables and an output table. The first input table contains measured data, and the second input table contains the coefficients of a numeric filter, The output table is the sum of the data in the first table, weighted by the coefficients in the second table. The attribute T04 then includes a reference to objects representing the two input tables, Attribute T05 then contains a reference to objects representing the output table.

Attribute T06 is a reference to task objects. Tasks corresponding to objects referenced by attribute T06 are used to produce Input tables. Tasks referenced by attribute T06 are called production tasks, and the task referencing them is called a consumer task. Output tables from production tasks are used as input tables by the consumer task. A task may be a production task with respect to one task, and a consumer task with respect to another task. Attribute T06 is used to build a tasks graph, demonstrating data production and data consumption relations (production tasks/Consumer tasks). It can also be used to determine the first precedence relations between tasks, A consumer task cannot be executed before a production task has been called.

The object task TA may also include other precedence information memorized in attribute T07. This information may consist of references to other task objects, It may be provided by the mapper, for example in the placement step E1.

The mechanism object class MC illustrated in FIG. 10 includes attributes M01, M02. Attribute M01 is a reference to a task object. Attribute M02 includes references to service objects.

Specialized object classes M1, M2, corresponding to calculation mechanisms and movement mechanisms respectively, include attributes that are specific to them. The calculation mechanism object class Ml includes attributes M10, M11,M12, M13, M14, M15. The movement mechanism object class M2 includes attributes M20, M21, M22.

Attributes M12, M13, M14 are used to determine which target architecture memories are used to memorize calculation task input tables and output tables respectively. These attributes may be defined by the mapper in the 2o mapping step P2.

Attributes M12, M13, M14 are used to determine the performance of the application placed during a simulation, Attribute M12 may correspond to the number of code lines necessary to exncute the mechanism on the target architecture. The use of this attribute durlng the simulation step E3 is used to determine the memory space necessary to execute the mechanism. Attribute M13 may correspond to the number of cycles necessary to initialize the calculation during an iteration, and at the end of the calculation. Attribute M14 may correspond to the numbers of inputs/outputs necessary during an iteration. Attributes M12, M13 and M14 may be defined by reading a file containing the list of mechanisms and their definitions A2. For example, attribute M13 may contain data containing the “CYCLES” keyword and attribute M14 may contain data fllowing the “IN” and OUrT keywors.

Attribute M15 is used to determine what calculation units will be used to execute the mechanism. This attribute may be defined by the mapper in the mapping step P2.

Attributes M2D and M21 are used to determine the source and destination memories of the movement mechanism. These attributes may be defined by reading a file containing the list of mechanisms and their definitions A2. For example, attribute M20 may contain data following the “SOURCE” keyword and attibute M21 may contain data following the “DEST ” keyword.

Attribute M22 is used to determine the number of data transferred per iteration. Each iteration can move several data from source memories to destination memories in each iteration. This attribute determines the number of data. It may be used in the simulation step to determine the execution speed of the data mrovement.

The service object class SC illustrated in 11 includes the attributes S01, S02, S03, S04, S05, S06, S07, S08.

Attribute S01 is a reference to a task object. Attribute S02 is a reference to a mechanism object. Attribute S03 determines the service category. For example, depending on its category, a service ray reserve resources, release resources, or do neither. This attribute may be defined during creation of the service object by a mechanisnm object. For example, the mechanism object includes a method used to create service objects. When this method is being executed, some attributes or service objects such as attribute S03 are initialized.

Attribute S04 is used to detennine the state of a service during a simulation E3. For example, a service may be in waiting (service in waiting state)f during execution (service in progress state), or execution may be terminated (service finished state). This attribute S04 is updated during the simulation.

Attributes S05 and S06 are used to determine progress with execution of the service. Attribute S05 defines the total number of iterations to be executed. In other words attribute S05 defines the initial number of iterations in the service. Attribute S06 is updated during the simulation and corresponds to the remaining number of iterations in the service. Before the segrice is started, the initial number of iterations is equal to the remaining number of iterations. The remaining number of iterations at the end of execution is zero.

Attribute S07 defines the service execution speed, This speed may be expressed as a number of cycles per iteration. In particular, it depends on use of the target architecture resources, It is updated during the simulation using the architecture model A3.

Attribute S08 includes references to service objects. These service obecs define the list of services to be waited for before the service can be executed.

This attribute S08 may be defined during the creation of the service object, particularly using attnbutes T06 and T07 of the task object in which the service object originated,

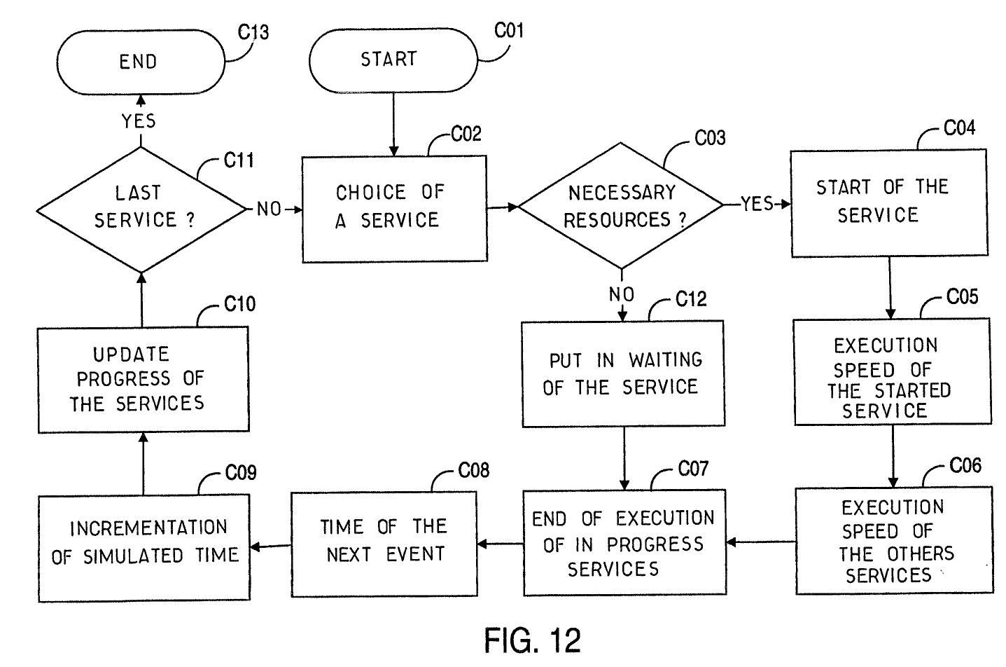

We shall now refer to FIG. 12 that illustrates a simulation example E3. At the beginning C01 of the simulation E3, the simulation engine G2 makes the choice C02 of a service to be started armong the sevices with an empty waiting list (attribute S08 of service objects). A test C03 is then carried out to deterrnine if the service has the necessary resources for its execution. If it does, the simulation engine starts the service during a step C04 and updates the service object attribute S04.

The execution speed of the started service is then defined in step C05, using the architecture model A3 and updating the attribute S07 of the corresponding service object. After the service has been started in step C05, the architecture resources are used differently. Similady, the execution E speed of other started services is then updated in step C06.

Attributes S06 and S07 of the started service objects are used in a step C07 to determine the end of execution times of in progress services. Attributes S06 and S07 are equal to the remaining number of iterations and the execution speed of the started services, respectively.

Then, during a step C08, the times determined in step C07 are compared to determine the time of the next event, in other words the event that will happen first in the simulation. In other words, steps C07 and C08 determine which service will finish execution first.

Then, in a step C09, the simulated time is incremented so that it is equal to the time of the next event determined in step C08. This simulated time may be memorized, for example in an attribute Ad thy simulation engine. Attributes S06 and S04 of services being executed are then updated in step C10.

Then during a test C11, it is determined if the last service during execution is finished (attribute S04). If so for the simulation, then the end of the simulation C13 has occurred. Otherwise, the simulation ontinues at step C02.

If it is impossible to start the selected service in test C03, the service will be put in waiting in step C12 and the simulation continues at step C07.

The simulation engine records pararneters such as the resource occupancy state or tasks currently being executed (in other words tasks for which services are currently being executed) with the simulated time, throughout this simulation. These parameters are performance indicators D4 for the placed application.

Obviously, the invention is not restricted to the exarmrples described above.

The workshop can be programmed using another language, the structure of descnrbed objects can be dir;rent, some objects can be repiacsd by object groups, and several objects can be grouped into a single object.

What is claim is:

1. Process for simulating a multiproessor application placed on a target architecture, characterized in that it includes at least the fillowing steps:
(a) a step (E2) to prepare the simulation to produce a services graph (D3), using firstly a tasks graph (D2) and secondly a list of mechanisms and their definition (A2);
(b) a step (E3) to execute the simulation to determine the performance of the placed appiication, using a behavioral model (A3) of the target 10 architecture and the services graph (D3).

2. Process for producing a multiprocessor application, characterized in that it includes at least the following steps:
(a) a step (E1) to place the application on the target architecture using firstly a functional description (D1) of said application, and secondly the list of resources (A1) of the target architecture in order to produce a tasks graph (D2);
(b) a step (E2) to prepare a simulation to produce a services graph (D3) starting firstly from a tasks graph (D2), and secondly from a Isst of mechanisms and their definitions (A2);
(c) a step (E3) to execute the simulation to deternine the performance of the placed apptication, using a behavioral model (A3) of the target architecture and the serv;ces graph (D3).

3. Process according to claim 2t characterized in that said placement step (E1) includes a partItioning step (P1) and a mapping step (P2).

4. Process according to any of the pevious claims, chanrcterized in that said simulation preparation step (E2) includes a step to create objects representing services, these objects being created by objects representing mechanisms.

5. Process according to any of the previous claims, characterized in that objects representing services of the target architecture are used during the stop (E3) to execute the simulation, the attributes of these objects being updated during the simulation as a function of how resources are used at the simulated timne.

6. Device used to create a multiprocessor application, characterized in that it includes;
(a) a placement aid (G1) that a mapper can use to place a functionally described application on a target architecture,
(b) an architecture model (A3) including behavioral models of elements of the architecture;
(c) a simulation engine (G2), using the architecture model to determine the performance of the placed application.

7. Device according to claim 6, characterized in that said architecture moei (A3) includes a generic interface independent of the target architecture that can be modified when the target architecture Is modified, without modifying the placement aid (G1) and without modifying the simulation engine (G2).

8. Device according t claim 6, characterized In that it includes means of reading firstly said list of resources (A1) of the target architecture, and secondly said list of mechanisms and their definitions (A2).
